(19) United States
(12) Patent Application Publication
(10) Pub. No.: US 2008/0101385 A1
(43) Pub. Date: May 1, 2008

(54) SYSTEM AND METHOD FOR FILTERING ROUTING UPDATES

(75) Inventors: MARK A. ELIAS, EASTPOINTE, MI (US); SHERRY SOJA-MOLLOY, ALLEN PARK, MI (US); THOMAS SPENCER, MORGANVILLE, NJ (US)

Correspondence Address: AKERMAN SENTERFITT, P.O. BOX 3188, WEST PALM BEACH, FL, 33402-3188, US

(73) Assignee: AT&T KNOWLEDGE VENTURES, L.P., RENO, NV (US)

(21) Appl. No.: 11/554,152

(22) Filed: Oct. 30, 2006

(51) Int. Cl. H04L 12/56

(52) U.S. Cl. 370/401; 370/351

(57) ABSTRACT

A system and method for filtering routing updates is disclosed. A system that incorporates teachings of the present disclosure may include, for example, a Route Reflector (RR) having a route reflection element that routes to one or more network elements a routing update according to a filter. Other embodiments are disclosed.

### FIELD OF THE DISCLOSURE

The present disclosure relates generally to packet switched networks, and more specifically to a system and method for filtering routing updates.

### BACKGROUND

At present, the size of an Internet routing table is approximately 250,000 entries. Combining this with the number of routing table entries for all the Virtual Private Networks (VPNs) that are also serviced by a common network, the size of this routing pool can easily double to almost ½ million entries. When this number of routes is multiplied by the number of routers in a typical service provider network, it is easy to see that routing updates can take up a substantial part of the network traffic load as well as being a burden on Provider Edge (PE) routers that are not a part of many of the VPNs for which they are receiving routing updates. At present, there is no means for applying a policy to routing updates to filter unwanted advertisements from being sent to PE routers.

A need therefore arises for a system and method for filtering routing updates.

### BRIEF DESCRIPTION OF THE DRAWINGS

FIG. 1 depicts an exemplary embodiment of a communication system;

FIG. 2 depicts an exemplary method operating in the communication system; and

FIG. 3 is a diagrammatic representation of a machine in the form of a computer system within which a set of instructions, when executed, may cause the machine to perform any one or more of the methodologies discussed herein.

### DETAILED DESCRIPTION

Embodiments in accordance with the present disclosure provide a system and method for filtering routing updates.

In a first embodiment of the present disclosure, a Route Reflector (RR) can have a route reflection element that advertises to one or more network elements a routing update according to a filter. The route reflection element can have a communications interface for processing packets from a plurality of network elements, a memory for storing the routing update, and a controller that manages operations of the route reflection element according to BGP (Border Gateway Protocol).

In a second embodiment of the present disclosure, a Provider Edge (PE) router can have a routing element that receives a routing update from an RR that restricts advertisement of the routing update according to a filter.

In a third embodiment of the present disclosure, a Customer Edge (CE) router can have a routing element that advertises by way of a Provider Edge (PE) router a routing update to an RR that restricts advertisement of the routing update according to a filter.

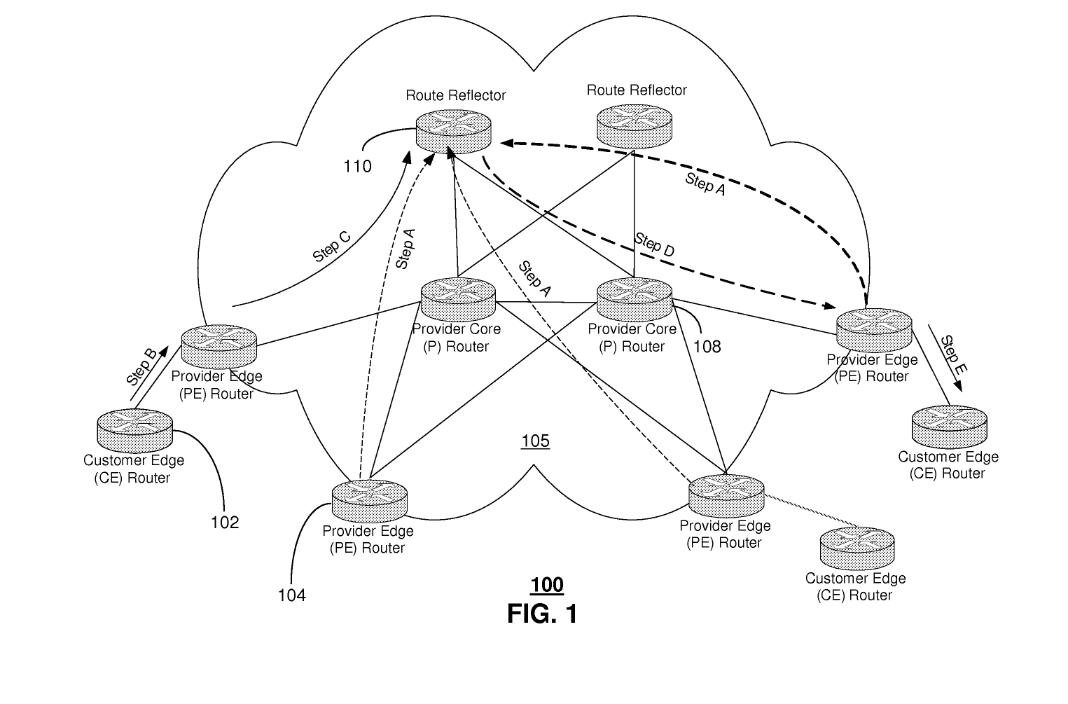

FIG. 1 depicts an exemplary embodiment of a communication system 100. The communication system 100 comprises Customer Edge (CE) routers 102 coupled to a corresponding Provider Edge (PE) router 104 which is part of a packet switching network having a plurality of network elements operating according to a Multi-Protocol Label Switching (MPLS) standard (“MPLS network 105”). The MPLS network 124 utilizes BGP (Border Gateway Protocol) to exchange routing information between said network elements. The MPLS network 105 includes among other things network elements such as common packet switching routers 108 and route reflectors (RR) 110 which are used for advertising routing updates throughout the MPLS network 105. The MPLS network 105 provides reachability between the PE routers 104 for exchanging packet traffic between the CE routers 102 belonging to the same Virtual Private Network (VPN).

The CE and PE routers 102, 104 include among other things a routing element for routing packets between network elements of the communication system 100. The RRs 110 include a route reflection element for re-advertising routing updates to a portion of said network elements. The routing and route reflection elements can represent hardware and/or software components commonly used in packet switching networks.

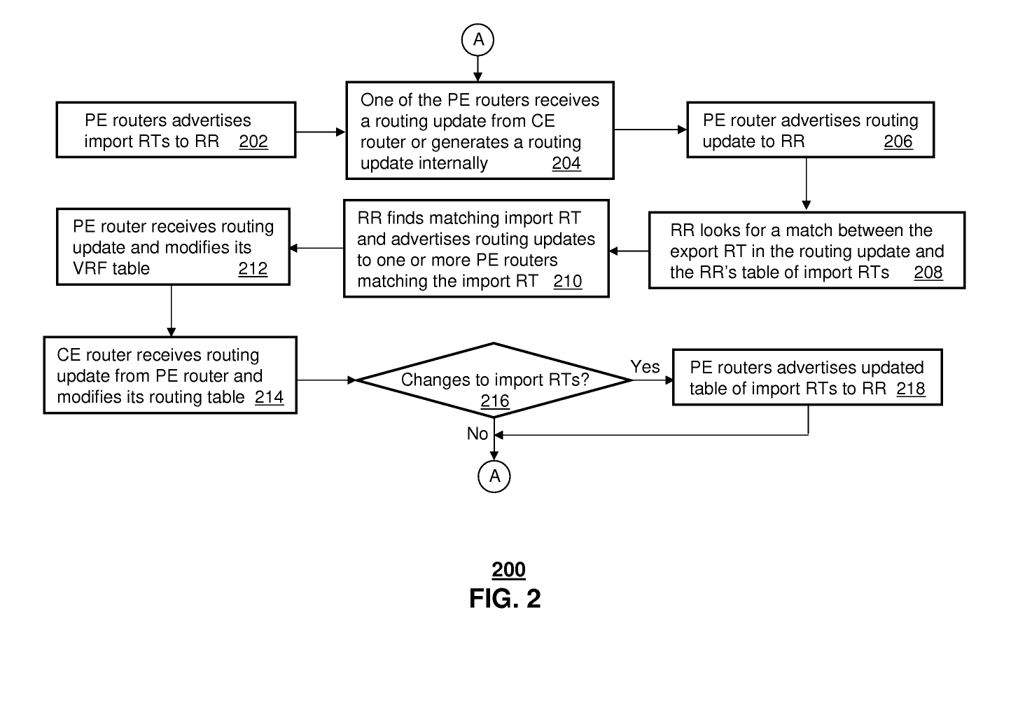

The functions of the aforementioned network elements can be described by an exemplary method 200 operating in the communication system 100 as depicted in FIG. 2. Method 200 begins with step 202 in which each of the PE routers 104 advertise their respective Import Route Targets (RTs) to a corresponding RR 110 (see Step A in FIG. 1). In step 202 the RR 110 stores the Import RTs to filter routing updates. Each of the Import RTs can correspond to one or more Virtual Private Networks (VPNs).

Once a RR 110 has stored the Import RTs of the PE routers 104 it is associated with, a PE router 104 in step 204 can either generate a routing update locally or receive a routing update from a corresponding CE router 102 (see Step B in FIG. 1) and advertise the routing update in step 206 to the RR 110 (see Step C in FIG. 1). The routing update includes among other things an Export Routing Target (RT) and routing attributes that could effect changes to a Virtual Routing and Forwarding (VRF) table of one or more PE routers in the communication system 100 of FIG. 1. Upon receiving the routing update in step 206, the RR 110 filters the routing update in step 208 by matching the Export RT to one or more Import RTs stored in the RR. The RR 110 will not re-advertise the routing update to PE routers 104 associated with Import RTs which do not match the Export RT. Thus the RR 110 in step 210 re-advertises the routing update only to PE routers 104 associated with an Import RT that matches the Export RT (see Step D in FIG. 1).

The PE router 104 receiving the routing update in step 212 in turn modifies its VRF table according to the routing information supplied in the routing update. This step can represent the addition, deletion or modification to existing entries in the VRF table of the PE router 104. To complete the updating process, the PE router 104 in step 214 can also advertise the routing update to CE routers 102 that are directly connected and are associated with the VPN identified by the Export RT so that each CE router 102 can update its own routing table accordingly.

To account for network configuration changes to the communication system 100, the PE routers 104 can be programmed in step 216 to identify changes to the Import RTs stored by them. If there is no change, the foregoing steps of method 200 starting with step 204 are repeated as needed. Otherwise, each of the PE routers affected by changes to their Import RTs advertises an updated table to the RR 110 in step 218, thereby affecting the foregoing filtering process described for the RR 110.

Method 200 as described above provides a new means to filter routing updates such that network elements of the communication system 100 having a need to know are given notice of said routing update. This method helps to decongest routing advertisements made by RRs 110 in MPLS VPN networks today.

From the foregoing descriptions, it would be evident to an artisan with ordinary skill in the art that the aforementioned embodiments can be modified, reduced, or enhanced without departing from the scope and spirit of the claims described below. Accordingly, the reader is directed to the claims below for a fuller understanding of the breadth and scope of the present disclosure.

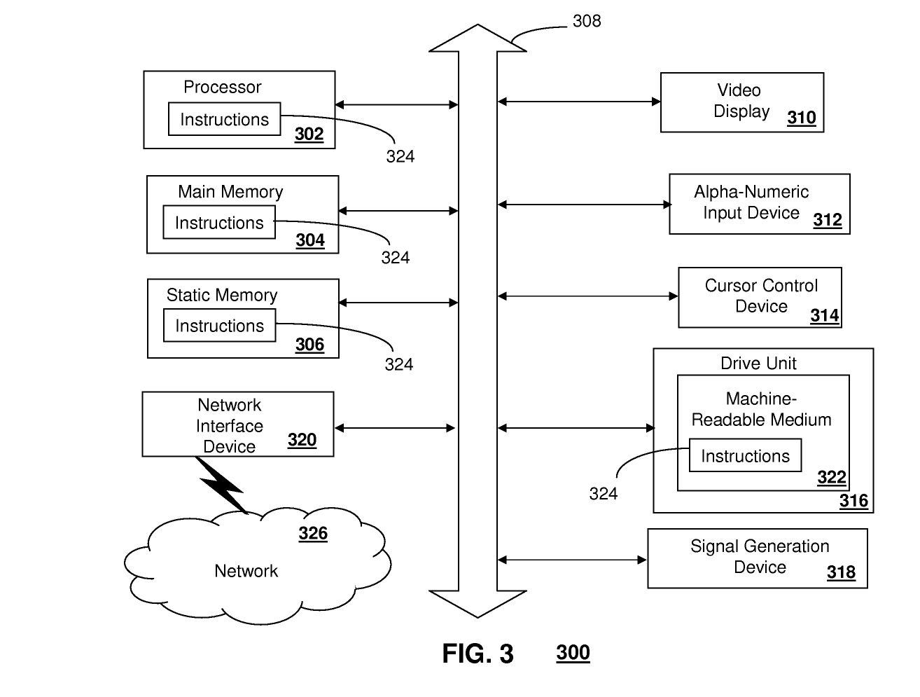

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A Route Reflector (RR), comprising a route reflection element that advertises to one or more network elements a routing update according to a filter, wherein the route reflection element comprises:
a communications interface for processing packets from a plurality of network elements;
a memory for storing the routing update; and
a controller that manages operations of the route reflection element according to BGP (Border Gateway Protocol).

2. The RR of claim 1, wherein the filter comprises matching an Export Route Target (RT) included in the routing update with one among a plurality of Import RTs stored in the RR.

3. The RR of claim 2, wherein each of the Import RTs corresponds to one or more Virtual Private Networks (VPNs).

4. The RR of claim 2, wherein the route reflection element receives the plurality of Import RTs from a plurality of network elements in a communication system comprising a packet switched network conforming to a Multi-Protocol Label Switching (MPLS) standard.

5. The RR of claim 4, wherein the route reflection element receives from one or more of the plurality of network elements an update to the plurality of Import RTs stored in the RR according to one or more updates taking place in the communication system.

6. The RR of claim 2, wherein the route reflection element suppresses advertising the routing update to one or more other network elements not matching the Export RT.

7. The RR of claim 1, wherein each of the one or more network elements comprises a Provider Edge (PE) router.

8. The RR of claim 1, wherein one among a PE router and a CE router is a source of the routing update.

9. A Provider Edge (PE) router, comprising a routing element that receives a routing update from a Route Reflector (RR) that restricts advertisement of the routing update according to a filter.

10. The PE router of claim 9, wherein the filter comprises matching an Export Route Target (RT) included in the routing update with one among a plurality of Import RTs stored in the RR.

11. The PE router of claim 9, wherein the routing element routes to the RR one or more Import Route Targets (RTs) stored in the PE router for filtering the routing update.

12. The PE router of claim 9, wherein the routing update includes an Export RT, and wherein the routing element updates a Virtual Routing and Forwarding (VRF) table associated with one among one or more Import RTs stored in the PE router that matches the Export RT.

13. The PE router of claim 9, wherein the routing element advertises the filtered routing update to a Customer Edge (CE) router for updating its routing table.

14. The PE router of claim 10, wherein each of the Import RTs corresponds to one or more Virtual Private Networks (VPNS) in a communication system.

15. The PE router of claim 10, wherein the routing element advertises to the RR an update to the plurality of Import RTs stored in the RR according to one or more updates taking place in the PE router.

16. The PE router of claim 9, wherein the routing element receives a second routing update from a CE router, and advertises said second routing update to the RR which advertises said second routing update to one or more network element in a communication system according to the filter.

17. The PE router of claim 9, wherein the routing element generates the routing update according to a local configuration and advertises said routing update to the RR which advertises said routing update to one or more network element in a communication system according to the filter.

18. A Customer Edge (CE) router, comprising a routing element that advertises by way of a Provider Edge (PE) router a routing update to a Route Reflector (RR) that restricts advertisement of the routing update according to a filter.

19. The CE router of claim 18, wherein the filter comprises matching an Export Route Target (RT) included in the routing update with one among a plurality of Import RTs stored in the RR.

20. The CE router of claim 18, wherein the routing element receives by way of a PE router a second routing update advertised by the RR according to the filter, and updates its routing table in response thereto.
